(19) United States
(12) Patent Application Publication
(10) Pub. No.: US 2026/0319479 A1
(43) Pub. Date: Oct. 15, 2026

(54) RISK VECTOR GENERATION SYSTEM

(71) Applicant: LOCUS CELL CO., LTD, New Taipei City (TW)

(72) Inventors: CHUN-YI LIN, New Taipei City (TW); CHIH WEI CHENG, New Taipei City (TW)

(21) Appl. No.: 19/467,887

(22) Filed: Feb. 3, 2026

Related U.S. Application Data
(60) Provisional application No. 63/754,604, filed on Feb. 6, 2025.

(51) Int. Cl. G05B 19/418

(52) U.S. Cl. CPC G05B 19/41875; G05B 2219/31461

(57) ABSTRACT

This invention provides a risk vector generation system, comprising a database, a large language model module, a risk assessment module, and a risk vector generation module. The database pre-stores a first standard operating procedure (SOP) and a risk calculation table. The large language model module is configured to receive a first instruction to generate N attribute data and determine whether the N attribute data match the first SOP. The risk assessment module is configured to receive the N attribute data and calculate a first risk priority number (RPN) based on the risk calculation table. The risk vector generation module is configured to receive the N attribute data that match the first SOP to generate M components and form a multi-dimensional risk vector with the first RPN. The risk vector generation system can quantify risks, reveal their relationships, and flexibly adapt to risk management across industries.

### BACKGROUND OF THE INVENTION

### 1. Field of the Invention

The present invention relates to a risk assessment system, particularly to a risk vector generation system according to quality management.

### 2. Description of the Prior Art

Conventional quality management systems mostly adopt a post-correction strategy. Namely, after the occurrence of quality issues, enterprises invest significant resources to quality correction, product recalls, and customer compensation. However, the post-correction strategy not only incurs high costs but also risks exposing the enterprises to regulatory penalties and damage to brand reputation, thereby undermining their competitiveness. Since the release of ISO 9001:2015, risk-based thinking has been formally incorporated into quality management systems. ISO 9001:2015 primarily emphasizes that enterprises should proactively identify and reduce risks when planning and executing quality management systems to prevent the occurrence of quality issues. To effectively execute risk-based management, enterprises must first identify the types of risks they may encounter and establish an appropriate risk classification framework according to business characteristics and industry requirements, ensuring that risk assessment and management measures can be systematically executed.

However, traditional risk classification methods are various. Different industries must establish suitable risk classification frameworks according to their product characteristics, supply chain structures, compliance requirements, and manufacturing environments to ensure quality management strategies can effectively control different risk types. As the scale of industries continues to expand and business processes grow increasingly complex, the range of risks faced by various industries also continues to broaden. Additionally, when risk management systems must encompass multi-tiered, multi-type risk assessments and simultaneously consider risk factors, the complexity of risk management and associated execution costs will increase. At the time of identifying and assessing risks, enterprises must invest significant time, manpower, and resources. It not only impacts decision-making efficiency but may also make it difficult for management mechanisms to accurately identify risks and implement timely controls.

Furthermore, the interdependence between the risk types are often overlooked due to fragmented information or limitations in risk assessment tools, making it difficult for enterprises to establish a comprehensive risk framework. When risk management strategies fail to effectively integrate internal and external risk factors, executives may misjudge the actual threats facing the enterprise, potentially impacting overall operational stability due to misidentification of key risks. Simultaneously, quality management is significantly influenced by risk management mechanisms. Without systematic risk assessment, monitoring, and auditing, product or service quality may become unstable, increasing defect rates and compliance risks. It also hinders the timely development of effective risk mitigation strategies.

### SUMMARY OF THE INVENTION

Therefore, the present invention provides a risk vector generation system including: a database pre-stored with a first standard operating procedure (SOP) and a risk calculation table; a large language model module connected the database and being configured to receive a first instruction to generate N attribute data and determine whether the N attribute data match the first SOP; a risk assessment module connected the database and the large language model module, and being configured to receive the N attribute data and calculate a first risk priority number (RPN) according to the risk calculation table; and a risk vector generation module connected to the large language model module and the risk assessment module, and being configured to receive the N attribute data that match the first SOP to generate M components and form a multi-dimensional risk vector with the first RPN. Wherein, N and M are both natural numbers greater than 1. The risk vector generation system of the invention can not only quantify all possible risks but also uncover the cumulative effects arising from interactions between potential risks. Additionally, the invention also has a high degree of flexibility, making it adaptable to the risk management requirements of various industries.

Wherein, the risk vector generation module is configured to generate the M components according to the N attribute data and the first SOP, and M is greater than N.

Wherein, the large language model module further includes a dynamic SOP generation unit, the first instruction further comprises a first regulatory data, the dynamic SOP generation unit retrieves the first regulatory data of the first instruction to generate a second SOP when the N attribute data do not match the first SOP.

Wherein, the database further includes a regulatory database, the dynamic SOP generation unit retrieves a second regulatory data of the regulatory database to generate a third SOP when the N attribute data do not match the first SOP.

Wherein, the second SOP and the third SOP are stored in a quality database of the database.

Wherein, the large language model module further includes a comparison unit configured to determine whether the N attribute data match the first SOP.

Wherein, the comparison unit comprises an artificial intelligence agent configured to compare the accuracy of the first SOP to automatically optimize the first SOP and adjust the first SOP.

Wherein, the M components further include a personnel component, a mechanical component, a material component, a regulatory component, an environmental component, an event component, and a time component.

Wherein, the N attribute data include a personnel attribute, an event attribute, a time attribute, a location attribute, and an object attribute.

Wherein, the risk assessment module further includes a negative RPN generation unit configured to generate a second RPN according to a severity index of the first RPN, and a detectability index and an occurrence index, which are pre-stored.

Wherein, the risk assessment module further includes a negative RPN generation unit configured to generate a second RPN according to a severity index of the first RPN, and a detectability index and an occurrence index, which are pre-stored.

In summary, the invention provides a risk vector generation system that not only significantly reduces reliance on manpower and resources for risk assessment while enhancing evaluation efficiency, but also specifically and precisely quantifies all potential risks. A large language model module of the invention converts a first instruction into N attribute data, and generates M components according to the N attribute data and a first SOP through a risk assessment module. Through the partition method of the M components, corresponding to the N attribute data. Wherein, M being greater than N indicates that more risk factors can be extracted from the N attribute data, with all risk factors categorized into appropriate components to construct a unified risk vector model. The method can ensure that all potential risk factors can be specifically identified and quantified to enhance the accuracy and practicality of risk assessment.

Additionally, after the all risk factors are integrated into a unified risk multidimensional vector, the relationships between various types of the risks can be clearly and specifically identified. The present invention may also uncover potential risk interaction mechanisms and cumulative effects through cross-analysis and statistical inference, enabling enterprises to promptly grasp risk trend shifts and thereby optimize response strategies.

Furthermore, the present invention employs a risk assessment method that integrates M components into a multidimensional risk vector, overcoming the limitations of traditional risk management caused by industry-specific risk categories. It achieves a standardized and scalable risk assessment framework. The present invention offers high adaptability and versatility, enabling flexible responses to risk management needs across various industries.

### BRIEF DESCRIPTION OF THE APPENDED DRAWINGS

FIG. 1 is a functional block diagram illustrating a risk vector generation system according to an embodiment of the present invention.

FIG. 2 is a functional block diagram illustrating a risk vector generation system according to another embodiment of the present invention.

FIG. 3 is flow diagram illustrating a risk vector generation system during operation according to an embodiment of the present invention.

### DETAILED DESCRIPTION OF THE INVENTION

For the sake of the advantages, spirits and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments.

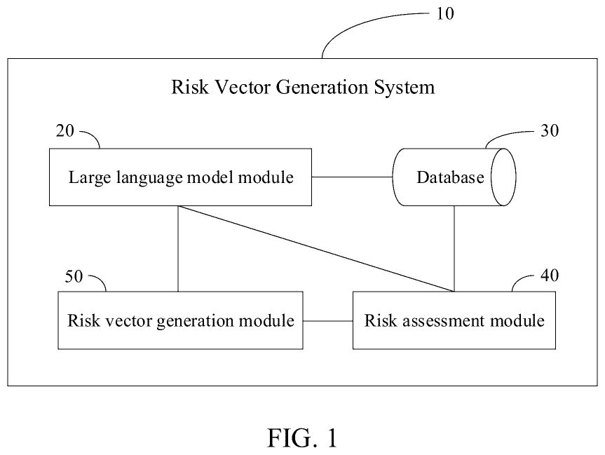

Please refer to FIG. 1. FIG. 1 is a functional block diagram illustrating a risk vector generation system 10 according to an embodiment of the present invention. As shown in FIG. 1, the risk vector generation system 10 provided by the present invention includes a database 30, a large language model module 20, a risk assessment module 40, and a risk vector generation module 50. In the present embodiment, the database 30 pre-stores a first standard operating procedure (SOP) and a risk calculation table. The large language model module 20 is connected to the database 30 and configured to receive a first instruction to generate N attribute data and determine whether the N attribute data match the first SOP. The risk assessment module 40 is connected to the database 30 and the large language model module 20, and is configured to receive the N attribute data and calculate and generate a first risk priority number (RPN) according to the risk calculation table. The risk vector generation module 50 is connected to the large language model module 20 and the risk assessment module 40, and is configured to receive the N attribute data that match the first SOP to generate M components and to form a multi-dimensional risk vector with the first RPN. The present invention provides a risk vector generation system applicable to Contract Development and Manufacturing Organization (CDMO) facilities, including product development and commercial manufacturing services for pharmaceuticals and biologics. In practice, not limited to this field, the present invention provides a risk vector generation system that can also be applied to other industries to address quality management requirements.

In the present embodiment, N and M are both natural numbers greater than 1. The M components include a personnel component, a mechanical component, a material component, a regulatory component, an environmental component, an event component, and a time component. The N attribute data include a personnel attribute, an event attribute, a time attribute, a location attribute, and an object attribute. However, in practice, the M components are not limited to the above field and may also be expanded as needed to encompass all risk factors and classification structures.

In the present embodiment, the risk vector generation module 50 can also generate the M components according to the N attribute data and the first SOP, where M is greater than N. The condition M greater than N indicates that additional risk factors can be extracted from these attribute data points and appropriately categorized into the respective components. The invention maximizes the capture and integration of all minute risk factors that are difficult for humans to perceive directly, ensuring the comprehensiveness and accuracy of risk assessment. However, in practice, not limited to it, M may also equal N.

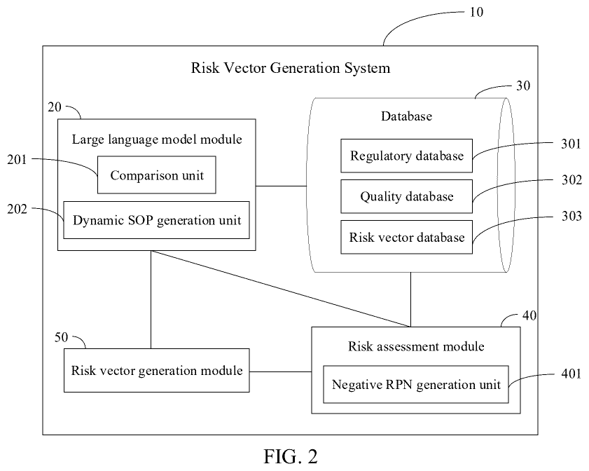

In addition to the above embodiments, the present invention may also encompass other application forms. Please refer to FIG. 2. FIG. 2 is a functional block diagram illustrating a risk vector generation system 10′ according to another embodiment of the present invention. As shown in FIG. 2, in the present embodiment, the risk vector generation system 10′ from the above embodiment in that the database 30 in the risk vector generation system 10′ can further include a regulatory database 301, a quality database 302 and a risk vector database 303; the large language model module 20 further includes a comparison unit 201 and a dynamic SOP generation unit 202; the risk assessment model module 40 further includes a negative RPN generation unit 401. In the present embodiment, the comparison unit 201 is configured to determine whether the N attribute data match the first SOP. The dynamic SOP generation unit 202 is configured to retrieve a first regulatory data in the first instruction to generate a second SOP, and retrieve a second regulatory data in the regulatory database 301 to generate a third SOP. In practice, not limited to it, the dynamic SOP generation unit 202 may also employ an artificial identification method to identify the first regulatory data within the first instruction for generating the second SOP, and to identify the second regulatory data within the regulatory database 301 for generating the third SOP. The regulatory database 301 can include national pharmaceutical regulations (such as FDA, EMA, TFDA), international standards (such as GMP, GLP, GCP, ISO 13485, ISO 9001), cell therapy-related guidelines (such as ATMP, ICH, USP <1046>), and environmental and biosafety regulations (such as BSL biosafety level requirements, EU REACH), but is not limited to these in practice. The quality database 302 can include internal standard operating procedures, internal quality management specifications, and internal audit and compliance documentation, but is not limited to these in practice. The risk vector database 303 is configured to store the multi-dimensional risk vector. The negative RPN generation unit 401 generates a second RPN according to the value of a severity index of the first RPN, and the values of a detectability index and an occurrence index, which are pre-stored. The second RPN is calculated by multiplying the values of the severity index, the detectability index and the occurrence index, then adding a negative sign to the result to generate a corresponding effective improvement measure.

In the present embodiment, the risk calculation table further includes the severity index, the detectability index and the occurrence index, configured to generate the first RPN of the first instruction. The first RPN is calculated by the risk assessment module 40 by multiplying the values of the severity index, the detectability index and the occurrence index according to the risk calculation table.

In the present embodiment, the negative RPN generation unit 401 generates the second RPN according to the values of the severity index, the detectability index and the occurrence index. The second RPN is less than zero. The risk vector generation module 50 receives the N attribute data to generate the M components, and to form the risk multidimensional vector. It should be note that, in the present embodiment, the risk vector generation system 10′ has components and modules that are the same as or correspond to those in the aforementioned embodiment. There have been described in the aforementioned embodiment and are therefore not repeated herein.

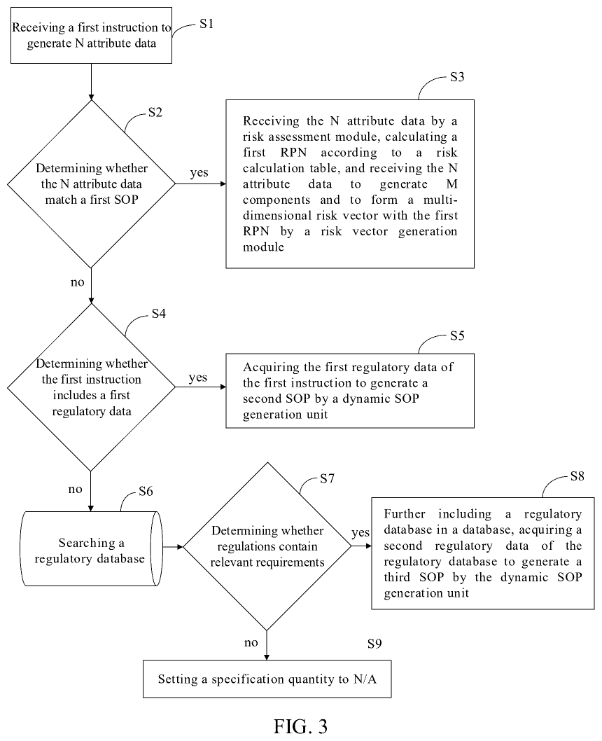

Please refer to FIG. 2 and FIG. 3. FIG. 3 is flow diagram illustrating the risk vector generation system 10′ during operation according to an embodiment of the present invention. As shown in FIG. 2 and FIG. 3, in the present embodiment, the risk vector generation system 10′ during operation includes the following steps: step S1: receiving the first instruction to generate the N attribute data; step S2: determining whether the N attribute data match the first SOP; if the N attribute data match the first SOP, proceed to step S3: receiving the N attribute data by the risk assessment module 40 and calculating the first RPN according to the risk calculation table, receiving the N attribute data to generate the M components and to form the multi-dimensional risk vector with the first RPN by the risk vector generation module 5; if the N attribute data do not match the first SOP, proceed to step S4: determining whether the first instruction further includes the first regulatory data; if the first instruction further includes the first regulatory data, proceed to step S5: acquiring the first regulatory data of the first instruction to generate the second SOP by the dynamic SOP generation unit 202; if first instruction does not further include the first regulatory data, proceed to step S6: searching the regulatory database 301; step S7: determining whether regulations contain relevant requirements; if the regulations contain the relevant requirements, proceed to step S8: further including the regulatory database 301 in the database 30, acquiring the second regulatory data of the regulatory database 301 to generate the third SOP by the dynamic SOP generation unit 202; if the regulations do not contain the relevant requirements, proceed to step S9: setting the specification quantity to N/A. In the present embodiment, the quality database 302 in the database 30 pre-stores the first SOP. The second SOP and the third SOP generated by the dynamic SOP generation unit 202 are stored to the quality database 302 of the database 30.

In another embodiment, the comparison unit 201 further includes an artificial intelligence agent, configured to compare the accuracy of the first SOP to automatically optimize and adjust the first SOP. In addition, the artificial intelligence agent can also determine whether product quality is compromised and whether there is a risk of customer injury, thereby generating determination result information. The risk assessment module 40 receives the above determination result information to generate the value of the severity index.

Please refer to FIG. 1 and FIG. 2. In practical application, the large language model module 20 receives the first instruction. The first instruction is: “On Jan. 1, 2025, the QC specialist operated a microscope in Laboratory R01 and forgot to turn off the power after use, resulting in the light source burning out.” The large language model module 20 receives the first instruction to form the N attribute data, including the personnel attribute, the event attribute, the time attribute, the location attribute, and the object attribute. The personnel attribute is “QC.” The event attribute is “failure to turn off the power after operating the microscope in accordance with the regulations to result in burnout of the light source.” The time attribute is “Jan. 1, 2025.” The location attribute is “Laboratory R01.” The object attribute is “microscope.” The comparison unit 201 of the large language model module 20 receives the first SOP in the quality database 302 of the database 30, configured to determine whether the N attribute data match the first SOP. The first SOP is all SOP data pre-stored in the quality database 302. After comparison with the comparison unit 201, the comparison unit 201 confirms that the event attribute, which the microscope was not powered off according to the regulations, resulting in the light source burning out, matches the “QC-Laboratory Microscope Operation Manual” in the quality database 302.

The risk vector generation module 50 is connected to the large language model module 20, receiving the above N attribute data to generate the M components. The M components are a serial number component, a personnel component, the mechanical component, the material component, the regulatory component, the environmental component, the event component, and the time component. The serial number component is a sequential numbering system. For the first instruction “On Jan. 1, 2025, the QC specialist operated a microscope in Laboratory R01 and forgot to turn off the power after use, resulting in the light source burning out,” the serial number component is “00100,” the personnel component is “QC,” the machine component is “microscope,” the material component is not classified and is therefore “N/A,” the regulatory component is “QC-Laboratory Microscope Operation Manual,” the environment component is “Laboratory R01,” the event component is “failure to turn off the power after operating the microscope in accordance with the regulations to result in burnout of the light source,” and the time component is “Jan. 1, 2025.”

The risk assessment module 40 is connected to the database 30 and the large language model module 20, configured to receive the N attribute data and calculate the first RPN according to the risk calculation table. The risk calculation table is as follows:

TABLE 1
the risk calculation table

| | Positive Risk | Negative Risk |
|---|---|---|
| | (Increase) | (Decrease) |
| Severity | 1 point: No relevant | The same as the event's |
| Index | regulations | score. |
| | 2 points: Violates relevant | |
| | regulations but does not | |
| | compromise quality | |
| | 3 points: Violates relevant | |
| | regulations, compromises | |
| | product quality, but does not | |
| | raise customer safety | |
| | concerns | |
| | 4 points: Violates relevant | |
| | regulations, compromises | |
| | product quality, and raises | |
| | customer safety concerns | |
| | 5 points: Violates relevant | |
| | regulations, compromises | |
| | product quality, and will | |
| | definitely compromise | |
| | customer safety | |
| Detectability | 1 point: Has SOP and AI | 1 point: No control measures |
| Index | detection systems | in place |
| | 2 points: Has SOP and | 2 points: Personnel |
| | automated detection systems | monitoring exists, but no |
| | 3 points: Has SOP and | SOP |
| | personnel monitoring | 3 points: Has SOP and |
| | 4 points: Has personnel | personnel monitoring |
| | monitoring but no SOP | 4 points: Has SOP and |
| | 5 points: No control | automated detection system |
| | measures whatsoever | 5 points: Has SOP and AI |
| | | detection system |
| Occurrence | 1 point: Never occurred | Initially set to 5 points and |
| Index | 2 points: Occurred once | start timing until the next |
| | within the past year | occurrence. Assign the final |
| | 3 points: Occurred once | score based on frequency: |
| | within the past six months | 1 point: Occurs once more |
| | 4 points: Occurred once | within one month |
| | within the past three months | 2 points: Occurs once more |
| | 5 points: Occurred once | within three months |
| | within the past month | 3 points: Occurs once more |
| | | within six months |
| | | 4 points: Occurs once more |
| | | within one year |
| | | 5 points: Never occurs again |

The risk assessment module 40 is connected to the regulatory database 301 to compare whether there is regulatory data matching the N attributes, and receives the determination result information of the artificial intelligence agent from the large language model module 20. The result generated by the risk assessment module 40 indicates that “failure to turn off the power after operating the microscope in accordance with the regulations to result in burnout of the light source” does not violate any pharmaceutical regulations but violates the operating guidelines of the “QC-Laboratory Microscope Operation Manual.” Although there is no direct risk to customer safety, the event may affect product quality; therefore, the value of the severity index is 3. The risk assessment module 40 is connected to the quality database 302 to compare a monitoring data in the quality database 302. The result generated by the risk assessment module 40 indicates that no AI detection system or automated detection system is installed at the microscope placement location in Laboratory R01, and only the relevant forms attached to the “QC-Laboratory Microscope Operation Manual” are used, with manual signatures serving as the basis for management. Therefore, the value of the detectability index is 3. The risk assessment module 40 is connected to the risk vector generation module 50 and the risk vector database 303, receiving the multidimensional vector of the first instruction generated by the risk vector generation module 50 to compare the risk vector database 303. The result generated by the risk assessment module 40 indicates that the non-time vectors in historical risk multidimensional vectors are identical to the non-time vectors of the risk multidimensional vector of the first instruction. In addition, the time vector thereof is “May 1, 2024.” Therefore, the value of the occurrence index is 2.

The risk assessment module 40 multiplies the values of the severity index, the detectability index and the occurrence index to generate the first RPN. The calculation formula for the first RPN is as follows:

First RPN=Severity index×Detectability index×Occurrence index

The calculated value is:

First RPN=3×3×2=18

The risk vector generation module 50 is connected to the large language model module 20, receiving the above N attribute data to generate the M components and to form the risk multidimensional vector with the first RPN. In practical application, the risk multidimensional vector is “00100, QC, microscope, N/A, QC-Laboratory Microscope Operation Manual, Laboratory R01, failure to turn off the power after operating the microscope in accordance with the regulations to result in burnout of the light source, Jan. 1, 2025, 18.”

The negative RPN generation unit 401 generates the second RPN according to the value of the severity index of the first RPN, and the values of the detectability index and the occurrence index, which are pre-stored. The second RPN is calculated by multiplying the values of the severity index, the detectability index and the occurrence index, then adding a negative sign to the result to generate a corresponding effective improvement measure. The calculation formula for the second RPN is as follows:

Second RPN=−(Severity index×Detectability index×Occurrence index)

In practical application, the value of the severity index of the second RPN is the value of the severity index of the first RPN, which is 3. The value of the detectability index of the second RPN is preset to “generating an automated detection system,” so the value is 4. The occurrence index of the second RPN is preset to “never occurred,” so the value is 5. The calculated value is:

Second RPN=−(3×4×5)=−60

The risk vector generation module 50 receives the N attribute data to generate the M components, and to form the risk multidimensional vector. in practical application, the risk multidimensional vector is “00100, QC, microscope, N/A, QC-Laboratory Microscope Operation Manual, Laboratory R01, failure to turn off the power after operating the microscope in accordance with the regulations to result in burnout of the light source, Jan. 1, 2025, −60.” The practical application demonstrates how the present invention automatically identifies and assesses risks in quality management through the large language model module 20, the risk assessment module 40, and the risk vector generation module 50. Through the comparison of risk vectors and the calculation of RPN, the preset invention can not only quantify the severity, detection capabilities, and occurrence of the risks, but also further generate a negative RPN to provide effective risk mitigation strategies.

This application case demonstrates that even if the issue does not violate pharmaceutical regulations, it may still impact product quality due to non-compliance with internal SOPs. Therefore, by comparing risk vectors with historical data, the risk level can be accurately assessed, and feasible corrective actions can be generated. The dynamic analysis mechanism of the present invention enables enterprises to respond to potential risks in real time, thereby enhancing quality control and management efficiency.

In summary, the invention provides a risk vector generation system that not only significantly reduces reliance on manpower and resources for risk assessment while enhancing evaluation efficiency, but also specifically and precisely quantifies all potential risks. A large language model module of the invention converts a first instruction into N attribute data, and generates M components according to the N attribute data and a first SOP through a risk assessment module. Through the partition method of the M components, corresponding to the N attribute data. Wherein, M being greater than N indicates that more risk factors can be extracted from the N attribute data, with all risk factors categorized into appropriate components to construct a unified risk vector model. The method can ensure that all potential risk factors can be specifically identified and quantified to enhance the accuracy and practicality of risk assessment.

Additionally, after the all risk factors are integrated into a unified risk multidimensional vector, the relationships between various types of the risks can be clearly and specifically identified. The present invention may also uncover potential risk interaction mechanisms and cumulative effects through cross-analysis and statistical inference, enabling enterprises to promptly grasp risk trend shifts and thereby optimize response strategies.

Furthermore, the present invention employs a risk assessment method that integrates M components into a multidimensional risk vector, overcoming the limitations of traditional risk management caused by industry-specific risk categories. It achieves a standardized and scalable risk assessment framework. The present invention offers high adaptability and versatility, enabling flexible responses to risk management needs across various industries.

It should be noted that relational terms in this specification, such as “first” and “second,” are used solely to distinguish one entity or operation from another, without requiring or implying any actual relationship or sequence between these entities or operations. Furthermore, the terms “including,” “having,” and “comprising,” along with other similar expressions, are intended to be equivalent in meaning and are open-ended. The inclusion of one or more items following any such term does not imply an exhaustive list of such items, nor does it imply limitation to the items listed.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A risk vector generation system for a manufacturing facility, comprising:
a memory storing a database, wherein the database pre-stores a first standard operating procedure (SOP) and a risk calculation table; and
at least one processor coupled to the memory and configured to execute;
a large language model module, configured to receive a first instruction comprising unstructured text related to a manufacturing event, convert the first instruction into N attribute data, and determine whether the N attribute data match the first SOP;
a risk assessment module, configured to receive the N attribute data and calculate a first risk priority number (RPN) according to the risk calculation table; and
a risk vector generation module, configured to receive the N attribute data that match the first SOP to generate M components and to form a risk multidimensional vector combining the M components with the first RPN;
wherein N and M are natural numbers greater than 1, and M is greater than N such that the risk vector generation module extracts additional risk factors derived from the N attribute data to construct the M components;
wherein the processor is further configured to generate an electronic output based on the risk multidimensional vector to render a visualization of the risk multidimensional vector on a user interface, thereby transforming the unstructured text into a quantifiable risk metric for the manufacturing facility.

2. The risk vector generation system of claim 1, wherein the risk vector generation module is configured to generate the M components according to the N attribute data and the first SOP.

3. The risk vector generation system of claim 1, wherein the large language model module further comprises a dynamic SOP generation unit, the first instruction further comprises a first regulatory data, the dynamic SOP generation unit retrieves the first regulatory data of the first instruction to generate a second SOP when the N attribute data do not match the first SOP.

4. The risk vector generation system of claim 3, wherein the database further comprises a regulatory database, the dynamic SOP generation unit retrieves a second regulatory data of the regulatory database to generate a third SOP when the N attribute data do not match the first SOP.

5. The risk vector generation system of claim 4, wherein the second SOP and the third SOP are stored in a quality database of the database.

6. The risk vector generation system of claim 1, wherein the large language model module further comprises a comparison unit configured to determine whether the N attribute data match the first SOP.

7. The risk vector generation system of claim 6, wherein the comparison unit comprises an artificial intelligence agent configured to compare the accuracy of the first SOP to automatically optimize the first SOP and adjust the first SOP.

8. The risk vector generation system of claim 1, wherein the M components further comprise a personnel component, a mechanical component, a material component, a regulatory component, an environmental component, an event component, and a time component.

9. The risk vector generation system of claim 1, wherein the N attribute data comprise a personnel attribute, an event attribute, a time attribute, a location attribute, and an object attribute.

10. The risk vector generation system of claim 1, wherein the risk assessment module further comprises a negative RPN generation unit configured to generate a second RPN according to a severity index of the first RPN, and a detectability index and an occurrence index, which are pre-stored.

11. The risk vector generation system of claim 10, wherein the second RPN is less than zero, the risk vector generation module is configured to receive the N attribute data to generate the M components and to generate a risk multidimensional negative vector with the second RPN.
